(19) United States
(12) Patent Application Publication
(10) Pub. No.: US 2023/0003589 A1
(43) Pub. Date: Jan. 5, 2023

(54) Temperature Calibration Method, System, and Electronic Device

(71) Applicant: ARIZE CORPORATION, Anaheim, CA (US)

(72) Inventors: Min WANG, Shenzhen (CN); Wenjun LONG, Shenzhen (CN)

(21) Appl. No.: 17/809,907

(22) Filed: Jun. 30, 2022

(30) Foreign Application Priority Data
Jun. 30, 2021 (CN) 202110741943.X

(51) Int. Cl. G01K 15/00

(52) U.S. Cl. CPC G01K 15/005

(57) ABSTRACT

The application provides a temperature calibration method, including: under a condition that first temperature data of a temperature sensor and second temperature data of a temperature controller meet a temperature equilibrium condition, calibrating real-time temperature data of the temperature controller; and under a condition that the first temperature data and the second temperature data do not meet the temperature equilibrium condition, determining a temperature calibration constant value according to third temperature data of the temperature sensor and fourth temperature data of the temperature controller when temperature control is not performed and performing temperature calibration, by using a temperature calibration formula including the temperature calibration constant value, on the real-time temperature data obtained by the temperature controller. The application can solve the problem of insufficient accuracy of the temperature measured. The application further provides a temperature calibration system, and an electronic device, which have the beneficial effects.

### REFERENCETORELATEDAPPLICATION

This is a non-provisional application which claims priority to a Chinese patent application having an application number of CN202110741943.X, and a filing date of Jun. 30, 2021, the entire contents of which is hereby incorporated by reference.

### TECHNICAL FIELD

The application relates to the field of environmental monitoring, and in particular, to a temperature calibration method, system, and electronic device.

### BACKGROUND

A current temperature controller is inaccurate in temperature measurement due to aging of components, dust accumulation on internal sensors, and relatively fast heat dissipation of a wall installed thereto. Finally, temperature control by the temperature controller is abnormal, causing people to feel that an indoor temperature is cold or hot.

In a temperature calibration method for the existing temperature controller, a temperature of an external reference thermometer is manually read and then manually written to the temperature controller, to calibrate a temperature sensor of the temperature controller. Disadvantages: A user is required to purchase a thermometer and needs to manually operate on an interface to input data, which is troublesome. Based on that cooling or heating is started indoor, the temperature indoor is distributed in a gradient at this time (during heating, the temperature at an air outlet is higher and the temperature in other places is lower), the temperature at a location of the temperature controller is different from the temperature at a location of the thermometer, and by directly inputting calibration data of the thermometer, a temperature data calibration error of the temperature controller may be caused, resulting in a greater error in a measured temperature of the temperature controller.

Therefore, how to improve the accuracy of temperature measurement of a temperature controller is a technical problem urgently to be solved by those skilled in the art.

### SUMMARY

The application provides a temperature calibration method, a temperature calibration system, and an electronic device, which can effectively calibrate the temperature measurement accuracy of a temperature controller.

To solve the technical problem, the application provides a temperature calibration method. The specific technical solution is as follows:

obtaining first temperature data of a temperature sensor and second temperature data of a temperature controller in a preset time period;

under a condition that the first temperature data and the second temperature data meet a temperature equilibrium condition, calibrating real-time temperature data of the temperature controller according to the first temperature data; and

under a condition that the first temperature data and the second temperature data do not meet the temperature equilibrium condition, determining a temperature calibration constant value according to third temperature data of the temperature sensor and fourth temperature data of the temperature controller when temperature control is not performed and performing temperature calibration, by using a temperature calibration formula including the temperature calibration constant value, on the real-time temperature data obtained by the temperature controller.

Optionally, the method further includes:

calculating a first variance corresponding to the first temperature data and a second variance corresponding to the second temperature data;

under a condition that the first variance and the second variance are both less than a preset threshold variance, determining that the first temperature data and the second temperature data meet the temperature equilibrium condition; and

under a condition that at least one of the first variance and the second variance is not less than the preset threshold variance, determining that the first temperature data and the second temperature data do not meet the temperature equilibrium condition.

Optionally, the determining the temperature calibration constant value according to the third temperature data of the temperature sensor and the fourth temperature data of the temperature controller when the temperature control is not performed and performing temperature calibration, by using the temperature calibration formula including the temperature calibration constant value, on the real-time temperature data obtained by the temperature controller includes:

when the temperature control is not performed, controlling the temperature controller in a preset manner to heat up or cool down, to respectively obtain temperature data before first temperature change and temperature data after first temperature change of the temperature sensor, and temperature data before second temperature change and temperature data after second temperature change of the temperature controller, where the third temperature data includes the temperature data before first temperature change and the temperature data after first temperature change and the fourth temperature data includes the temperature data before second temperature change and the temperature data after second temperature change;

substituting the temperature data before first temperature change and the temperature data before second temperature change as data before temperature change into the temperature calibration formula, substituting the temperature data after first temperature change and the temperature data after second temperature change as data after temperature change into the temperature calibration formula, and obtaining the temperature calibration constant value through calculation, where the temperature calibration constant value is positively correlated with a quantity of temperature sensors included in the temperature controller; and

performing the temperature calibration, by using the temperature calibration formula including the temperature calibration constant value, on the real-time temperature data obtained by the temperature controller.

Optionally, under a condition that the temperature controller includes a first temperature sensor and a second temperature sensor, the temperature calibration formula is:

t=t₁−(a+Δₜ₁*b)*(t₂−t₁)

wherein t is an external ambient temperature after calibration, t₁ is a measured temperature of the first temperature sensor, t₂ is a measured temperature of the second temperature sensor, Δₜ₁ is a temperature change rate of the first temperature sensor, and a and b are the temperature calibration constant values.

Optionally, the method further includes: under a condition that a latest control instruction of the temperature controller in the preset time period is to terminate a temperature control operation, determining that the temperature control is not performed currently.

Optionally, before the obtaining first temperature data of the temperature sensor and second temperature data of the temperature controller in the preset time period, the method further includes:

determining an actual distance between the temperature sensor and the temperature controller according to a signal strength value; and

under a condition that the actual distance is less than a set distance, performing operation of the obtaining first temperature data of the temperature sensor and second temperature data of the temperature controller in a preset time period.

Optionally, after the obtaining the first temperature data of the temperature sensor and the second temperature data of the temperature controller in the preset time period, the method further includes:

under a condition that a difference between the first temperature data and the second temperature data is not less than a preset threshold, triggering operation of determining whether the first temperature data and the second temperature data meet the temperature equilibrium condition, and performing the temperature calibration; and

under a condition that the difference between the first temperature data and the second temperature data is less than the preset threshold, skipping the temperature calibration.

Optionally, the determining an actual distance between the temperature sensor and the temperature controller according to a signal strength value includes:

inputting the signal strength value to a preset conversion formula, to obtain the actual distance between the temperature sensor and the temperature controller, where

the preset conversion formula is:

d=10^{(abs(RSSI)-A)/(10*n)}

where d is a distance between the temperature sensor and the temperature controller, A is an absolute value of power at a unit distance from the temperature sensor, n is free space loss, and the unit of an RSSI is decibels referenced to one milliwatt (dbm).

The application further provides a temperature calibration system, including:

a temperature obtaining circuitry, configured to obtain first temperature data of a temperature sensor and second temperature data of a temperature controller in a preset time period;

a first calibration circuitry, configured to, based on that the first temperature data and the second temperature data meet a temperature equilibrium condition, calibrate real-time temperature data of the temperature controller according to the first temperature data; and

a second calibration circuitry, configured to, based on that the first temperature data and the second temperature data do not meet the temperature equilibrium condition, determine a temperature calibration constant value according to third temperature data of the temperature sensor and fourth temperature data of the temperature controller when temperature control is not performed and perform temperature calibration, by using a temperature calibration formula including the temperature calibration constant value, on the real-time temperature data obtained by the temperature controller.

The application further provides a computer-readable storage medium, storing a computer program, where the computer program, when executed by a processor, implements the operations of the temperature calibration method.

The application further provides an electronic device, including a memory and a processor, where the memory stores a computer program, and the processor, when invoking the computer program stored in the memory, implements the operations of the temperature calibration method.

The application provides a temperature calibration method, including: obtaining first temperature data of a temperature sensor and second temperature data of a temperature controller in a preset time period; under a condition that the first temperature data and the second temperature data meet a temperature equilibrium condition, calibrating real-time temperature data of the temperature controller according to the first temperature data; and under a condition that the first temperature data and the second temperature data do not meet the temperature equilibrium condition, determining a temperature calibration constant value according to third temperature data of the temperature sensor and fourth temperature data of the temperature controller when temperature control is not performed and performing temperature calibration, by using a temperature calibration formula including the temperature calibration constant value, on the real-time temperature data obtained by the temperature controller.

In the application, temperature data of the temperature sensor and the temperature controller are obtained respectively, and whether a current environment is in temperature equilibrium is determined according to the temperature data of the temperature sensor and the temperature controller. When the current environment is in a temperature equilibrium state, that is, the temperature equilibrium condition is met, the real-time temperature data of the temperature controller can be calibrated by directly using the first temperature data acquired by the temperature sensor. Under a condition that the temperature equilibrium condition is not met, temperature data newly acquired by the temperature sensor and the temperature controller is used to determine a temperature calibration constant value when temperature control is not performed, so that the temperature calibration constant value is used to calibrate the real-time temperature data. The application can solve the problem of insufficient accuracy of the temperature measured by the temperature controller due to temperature imbalance caused by temperature control, and effectively improve the accuracy of temperature measurement of the temperature controller, thereby further improving the temperature control effect of the temperature controller.

The application further provides a temperature calibration system, a computer-readable storage medium, and an electronic device, having the beneficial effects, which are not repeated herein.

### BRIEF DESCRIPTION OF THE DRAWINGS

To explain the embodiments of the application or the technical solutions in the prior art more clearly, the following will briefly describe the accompanying drawings that need to be used in the description of the embodiments or the prior art. Obviously, the accompanying drawings in the following description show only the embodiments of the application, and those of ordinary skill in the art can still derive other accompanying drawings from these accompanying drawings without creative efforts.

FIG. 1 is a flow diagram of a temperature calibration method according to an embodiment of the application.

FIG. 2 is a flow diagram of another temperature calibration method according to an embodiment of the application.

FIG. 3 is a schematic structural diagram of a temperature calibration system according to an embodiment of the application.

FIG. 4 is a schematic structural diagram of an electronic device according to an embodiment of the application.

### DETAILED DESCRIPTION OF THE PREFERRED EMBODIMENT

To make the objective, technical solutions, and advantages of the embodiments of the application clearer, the following clearly and completely describes the technical solutions in the embodiments of the application with reference to accompanying drawings in the embodiments of the application. Obviously, the described embodiments are merely some rather than all of the embodiments of the application. Based on the embodiments of the application, all other embodiments obtained by those of ordinary skill in the art without creative efforts shall fall in the scope of protection of the application.

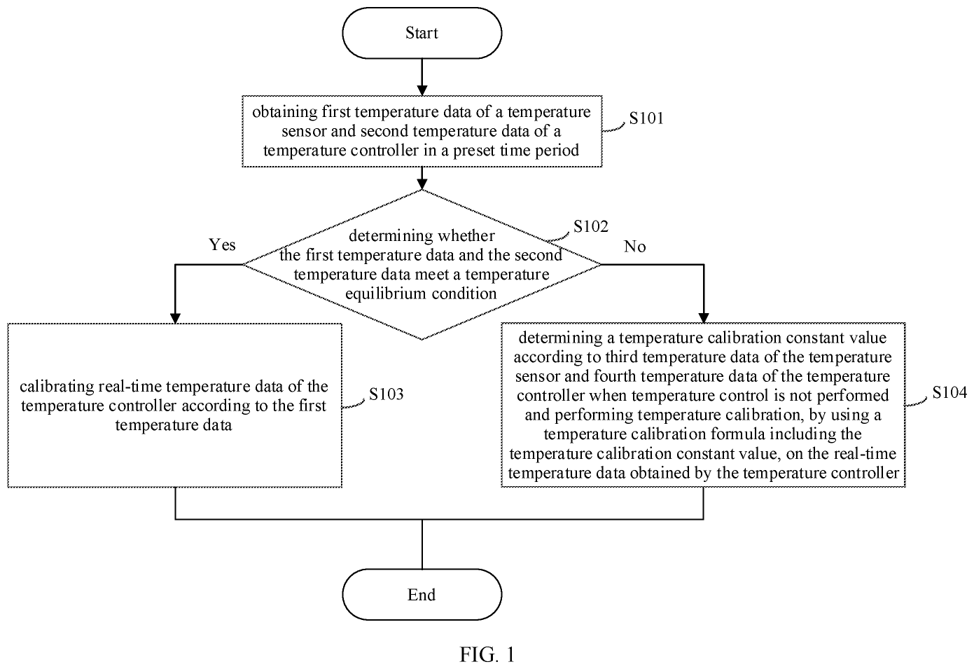

FIG. 1 is a flow diagram of a temperature calibration method according to an embodiment of the application. The includes the following steps.

S101: obtaining first temperature data of a temperature sensor and second temperature data of a temperature controller in a preset time period.

This step is intended to obtain the first temperature data and the second temperature data. A connection mode between the temperature sensor and the temperature controller is not specifically limited herein, and generally a wireless connection may be used, including but not limited to, wireless communication technologies such as Bluetooth, infrared, or zigbee, or wireless communication standards. Certainly, a wired connection may also be used to facilitate direct wired transmission of the first temperature data of the temperature sensor.

A type and model of the temperature sensor are not limited herein. It should be noted that the temperature sensor may be a sensor including a temperature detection function, for example, a temperature and humidity sensor can also be used in this embodiment of the application. In other words, any sensor capable of measuring the first temperature data can be regarded as the temperature sensor in the application.

In addition, the second temperature data of the temperature controller in this embodiment refers to a temperature detected by the temperature controller. Because different temperature controllers have different structures, the temperature controller includes at least one built-in temperature sensor, and when the temperature controller includes a plurality of built-in temperature sensors, the second temperature data obtained in this step is a unique output temperature obtained through corresponding calculation of temperature data of each built-in temperature sensor in the preset time period; or the second temperature data is a set of temperature data of each built-in temperature sensor in the preset time period. How the temperature controller obtains the second temperature data is not specifically limited herein, and a preset formula or temperature model maybe used to calculate the temperature detected by each built-in temperature sensor, so as to obtain the second temperature data.

Preferably, the temperature controller in this embodiment may be connected to a Heating, Ventilation and Air Conditioning (HVAC) system, and the HVAC system is controlled according to the second temperature data provided by the temperature controller and a set temperature control strategy, to perform indoor temperature control. For example, in this embodiment of the application, calibration is performed, by using the solution of this embodiment of the application, on a real-time temperature provided by the temperature controller, to obtain a target detected temperature of the temperature controller, which is then used in combination with a target temperature control strategy set by a user, to control the HVAC system to perform the indoor temperature control.

In this embodiment, the preset time period is not specifically limited, and duration of the time period may be set by those skilled in the art according to an actual temperature measurement requirement. For example, under a condition that no significant temperature change occurs in an environment to be measured, long duration, such as 5 min, may be chosen. Under a condition that a significant temperature change occurs in an environment to be measured, such as a relatively great temperature change caused by a temperature control operation such as cooling or heating, the duration of the preset time period may be chosen to be shorter, such as 5 s, 30 s, or 1 min. The preset time period may be a historical time period closest to a current time.

S102: determining whether the first temperature data and the second temperature data meet a temperature equilibrium condition; if so, entering S103; or if not, entering S104.

Step S102 is an optional step.

This step is intended to determine temperature equilibrium on a current external environment under first temperature data and the second temperature data obtained. The temperature equilibrium condition means that a difference in the temperature of an environment where the temperature sensor and the temperature controller are located is small and the temperature is relatively balanced. How to determine whether the temperature equilibrium condition is met is not specifically limited herein, and any determining method capable of feeding back a degree of dispersion of temperature data can be used, including but not limited to, data such as a variance and a standard deviation. Preferably, this embodiment provides a process for determining on a temperature equilibrium condition based on a variance.

Step 1: calculating a first variance corresponding to the first temperature data and a second variance corresponding to the second temperature data.

Step 2: determining whether the first variance and the second variance are both less than a preset threshold variance; if so, entering step 3; or if not, entering step 4. The determining step is also an optional step.

Step 3: determining that the first temperature data and the second temperature data meet a temperature equilibrium condition.

Step 4: determining that the first temperature data and the second temperature data do not meet a temperature equilibrium condition.

Step 4 is specifically for a case where the first variance and the second variance are both not less than the preset threshold variance, or only one of the first variance and the second variance is less than the preset threshold variance and the other one is not less than the preset threshold variance.

Under a condition that the second temperature data is a unique output temperature of the temperature controller at a specific time, one second variance is calculated; under a condition that the second temperature data is a set of temperature data of a plurality of built-in temperature sensors, second variances corresponding to the built-in temperature sensors may be calculated respectively, that is, one temperature sensor corresponds to one second variance, which is not limited herein. The determining that the temperature equilibrium condition is met may indicate: a case where the first variance and the second variances are all less than the preset threshold variance.

The preset threshold variance is not specifically limited herein, and may be set by those skilled in the art, for example, may be set to 0.03, that is, the first variance and the second variance being both less than 0.03 indicates that temperature fluctuation is relatively small; and in this case, the external environment may be considered to meet the temperature equilibrium condition. Under a condition that at least one of the first variance and the second variance is greater than 0.03, the temperature equilibrium condition is considered to be not met. Certainly, 0.03 is merely a specific preset threshold variance value provided in this embodiment, and those skilled in the art may also set different precision of the preset threshold variance according to a scenario and environment to which the temperature detection is applied, for example, 0.04, 0.02, or even 0.1 all may be used, which is not exhaustively limited herein.

S103: calibrating real-time temperature data of the temperature controller according to the first temperature data.

Under a condition that the temperature equilibrium condition is met, the first temperature data of the temperature sensor may be directly used, as target temperature data after calibration by the temperature controller, to calibrate the real-time temperature data of the temperature controller. It should be noted that the calibration usually means calibrating current or subsequent real-time temperature data obtained by the temperature controller. How to use the temperature data of the temperature sensor to calibrate the real-time temperature data of the temperature controller is not specifically limited herein.

In a possible solution, temperature data acquired by the temperature sensor in real time may be directly used as the target temperature data after calibration of the temperature controller at the same time, so that a corresponding temperature control instruction is sent according to the real-time temperature data.

Alternatively, in another possible solution, an average of temperature data acquired by the temperature sensor at a specific time and temperature data of the temperature controller at the same time is used as the target temperature data after calibration of the temperature controller at the time.

Alternatively, in another possible solution, a difference, ratio, or the like between the first temperature data and the second temperature data is used as a parameter to calibrate, in a correction manner, subsequent real-time temperature data of the temperature controller.

Alternatively, in another possible solution, under a condition that the temperature controller includes two or more built-in temperature sensors, the real-time temperature data in this step may include temperature data detected by the built-in temperature sensors. Correspondingly, when the real-time temperature data is calibrated by using the first temperature data, calibration may be performed after a unique output temperature is obtained through corresponding calculation of temperature data detected by the plurality of built-in temperature sensors, or calibration may also be performed by using a preset calibration formula. For example, the temperature controller includes two built-in temperature sensors (respectively, a first temperature sensor and a second temperature sensor), and description is provided below.

A: selecting first temperature data at a first time and first temperature data at a second time from the first temperature data, obtaining temperature data acquired by the first temperature sensor at the first time and temperature data acquired by the first temperature sensor at the second time, then obtaining temperature data acquired by the second temperature sensor at the first time and temperature data acquired by the second temperature sensor at the second time, and substituting the temperature data into a temperature calibration formula, for calculating to obtain a temperature calibration constant value.

A temperature calibration formula provided herein is:

t=t₁−(a+Δₜ₁*b)*(t₂−t₁)

t is temperature data after calibration, that is, an external ambient temperature after the temperature controller is calibrated, and is used for performing a corresponding temperature control operation according to an actual value of t. t₁ is a measured temperature of the first temperature sensor, t₂ is a measured temperature of the second temperature sensor, Δₜ₁ is a temperature change rate of the first temperature sensor, and a and b are temperature calibration constant values. The temperature change rate means a ratio of the measured temperature of the first temperature sensor to time. A value range of a may be any value in a range of 1-5, and b is any value in a range of 0.1-1. a and b are both mainly affected by the placement of the built-in temperature sensors and the product structure of the temperature controller.

By substituting the first temperature data t at the first time, the temperature t₁ acquired by the first temperature sensor, and the temperature t₂ acquired by the second temperature sensor into the formula, and subsequently substituting the first temperature data t at the second time, the temperature t₁ acquired by the first temperature sensor, and the temperature t₂ acquired by the second temperature sensor into the formula, the temperature change rate Δₜ₁ of the first temperature sensor can be obtained through calculation, and in this case, an equation with known data except for that a and b are unknown can be obtained, to further obtain values of the temperature calibration constant value a and the temperature calibration constant value b.

Certainly, it should be easily appreciated that, under a condition that the temperature controller includes three or more built-in temperature sensors, a quantity of the temperature calibration constant values may be increased correspondingly, and the temperature calibration constant value is positively correlated with a quantity of temperature sensors included in the temperature controller.

B: performing temperature calibration, by using the temperature calibration formula including the temperature calibration constant value, on the real-time temperature data obtained by the temperature controller.

After the temperature calibration constant value in the temperature calibration formula is determined through the step, the temperature calibration may be performed on a real-time temperature (for example, including a real-time temperature acquired by the first temperature sensor and a real-time temperature acquired by the second temperature sensor) acquired by the temperature controller, to obtain a unique output temperature for temperature control. In this step, the real-time temperature may include temperature data measured by the built-in temperature sensors in the temperature controller.

S104: determining a temperature calibration constant value according to third temperature data of the temperature sensor and fourth temperature data of the temperature controller when temperature control is not performed and performing temperature calibration, by using a temperature calibration formula including the temperature calibration constant value, on the real-time temperature data obtained by the temperature controller.

The third temperature data and the first temperature data are temperature data acquired at different times, and the fourth temperature data and the second temperature data are temperature data acquired at different times.

Under a condition that the equilibrium condition is not met, for example, at least one of the first variance and the second variance is greater than the preset threshold variance, the temperature calibration constant value may be determined first, and then the temperature calibration is performed on the real-time temperature data obtained by the temperature controller in combination with the corresponding temperature calibration formula. The temperature calibration formula and the temperature calibration constant value are not specifically limited herein, and may be determined in combination with the quantity of built-in temperature sensors included in the temperature controller and the structure of the built-in temperature sensor.

In the application, temperature data of the temperature sensor and the temperature controller are obtained respectively, and whether a current environment is in temperature equilibrium is determined according to the temperature data of the temperature sensor and the temperature controller. When the current environment is in a temperature equilibrium state, that is, the temperature equilibrium condition is met, the real-time temperature data of the temperature controller can be calibrated by directly using the temperature data acquired by the temperature sensor. Under a condition that the temperature equilibrium condition is not met, temperature data newly acquired by the temperature sensor and the temperature controller is used to determine a temperature calibration constant value when temperature control is not performed, so that the temperature calibration constant value is used to calibrate the real-time temperature data. The application can solve the problem of insufficient accuracy of the temperature measured by the temperature controller due to temperature imbalance caused by temperature control, and effectively improve the accuracy of temperature measurement of the temperature controller, thereby further improving the temperature control effect of the temperature controller.

Under a condition that an HVAC system is used for temperature control, during the temperature control, the indoor temperature can be divided into four stages no matter for cooling or hearing, namely:

Before the temperature control: The temperature in all locations in the room is relatively close and the temperature distribution in the room is relatively uniform.

Just when the temperature control is performed: The temperature at a location closer to an air outlet starts to rise/decrease, and the temperature at a location away from the air outlet can start to rise/decrease only after a relative lag time t, where the lag time t is negatively correlated with a wind speed of the HVAC system, and t is negatively correlated with a distance between the temperature sensor and the temperature controller.

During the temperature control: The temperatures at two locations, namely, measured by the temperature sensor and the temperature controller are slowly rising/decreasing, and the temperature closer to the air outlet is higher/lower.

When the temperature control stops: The temperatures at the two locations may slowly decrease/rise, and the temperatures at the two locations may get closer and closer. In this case, the indoor temperature distribution is relatively uniform.

Therefore, based on the embodiments, preferably, this embodiment is intended to describe how to determine a temperature calibration constant value according to third temperature data of the temperature sensor and fourth temperature data of the temperature controller when temperature control is not performed and perform temperature calibration, by using a temperature calibration formula including the temperature calibration constant value, on the real-time temperature data obtained by the temperature controller. The process may include the following steps.

Step 1: determining whether a temperature control is performed currently; if not, entering step 2.

In this step, first whether the temperature control is performed is determined, how to detect whether the temperature control is performed is not specifically limited herein, and specifically, may be determined by determining whether a latest control instruction of the temperature controller in the preset time period is to terminate the temperature control operation. Under a condition that the latest control instruction is to terminate the temperature control operation, it is determined that the temperature control is not performed currently, and otherwise, it is determined that the temperature control is performed currently. Certainly, in the process, detection for a temperature control instruction sent by the temperature controller is needed. Certainly, under a condition that the temperature control instruction is sent by another control device, the latest control instruction may also be obtained accordingly.

Under a condition that the temperature control is just performed or is currently in progress, the temperature calibration of this embodiment cannot be applied in this case.

Step 2: determining a temperature calibration constant value according to third temperature data of the temperature sensor and fourth temperature data of the temperature controller and performing temperature calibration, by using a temperature calibration formula including the temperature calibration constant value, on the real-time temperature data obtained by the temperature controller, where the first step of determining is an optional step.

Specifically, the temperature controller may be controlled in a preset manner to heat up or cool down when the temperature control is not performed, to respectively obtain the temperature data before first temperature change and the temperature data after first temperature change of the temperature sensor, and the temperature data before second temperature change and the temperature data after second temperature change of the temperature controller.

It can be seen from the above that whether it is at the beginning of the temperature control or during the temperature control, a corresponding difference exists between degrees of temperature change of the temperature sensor and the temperature controller due to a difference in distances of the temperature sensor and the temperature controller from the air outlet. In this case, a calibration deviation of the temperature calibration, if performed, is relatively great. Therefore, the temperature calibration is performed when the temperature control is not performed, that is, in two cases when the temperature equilibrium condition is met, namely, before the temperature control is performed and after the temperature control is stopped.

Specifically, a heating or cooling operation is performed on the temperature controller, and temperature data before temperature change and temperature data after temperature change are obtained, respectively. How to perform the heating or cooling operation is not specifically limited herein, and may be performed by turning on a screen backlight of the temperature controller, or turning on a component capable of generating heat of the temperature controller, so that the entire temperature controller generates heat, so as to obtain the temperature data after temperature change. Certainly, other methods may also be used to perform cooling, so as to obtain temperature data before and after temperature change.

The third temperature data includes temperature data before first temperature change and temperature data after first temperature change of the temperature sensor, and the fourth temperature data includes temperature data before second temperature change and temperature data after second temperature change.

It should be noted that, under a condition that the temperature controller includes a plurality of built-in temperature sensors, the temperature data before second temperature change and the temperature data after second temperature change respectively include a plurality of pieces of temperature data before temperature change and a plurality of pieces of temperature data after temperature change, and each built-in temperature sensor corresponds to one piece of temperature data before temperature change and one piece of temperature data after temperature change.

Step 3: substituting the temperature data before first temperature change and the temperature data before second temperature change as data before temperature change into the temperature calibration formula, substituting the temperature data after first temperature change and the temperature data after second temperature change as data after temperature change into the temperature calibration formula, and obtaining the temperature calibration constant value through calculation.

This embodiment provides a temperature calibration formula. Under a condition that the temperature controller includes two built-in temperature sensors, namely, a first temperature sensor and a second temperature sensor, the temperature calibration formula may be:

t=t₁−(a+Δₜ₁*b)*(t₂−t₁)

t is an external ambient temperature after calibration, that is, an external ambient temperature after the temperature controller is calibrated, and is used for performing a corresponding temperature control operation according to an actual value of t. t₁ is a measured temperature of the first temperature sensor, t₂ is a measured temperature of the second temperature sensor, Δₜ₁ is a temperature change rate of the first temperature sensor, and a and b are temperature calibration constant values. The temperature change rate means a ratio of the measured temperature of the first temperature sensor to time. A value range of a may be any value in a range of 1-5, and b is any value in a range of 0.1-1. a and b are both mainly affected by the placement of the built-in temperature sensors and the product structure of the temperature controller.

When the temperature data before first temperature change and the temperature data before second temperature change are substituted, the temperature data before first temperature change is used as t , and t₁ and t₂ are included in the temperature data before second temperature change. In addition, given that t₁ is known, a temperature change rate Δₜ₁ of the first temperature sensor can be obtained, and in this case an equation with known data except for that a and b are unknown can be obtained. Similarly, by substituting the temperature data after first temperature change and the temperature data after second temperature change, another equation can be obtained. In this case, a binary primary equation system with a and b as unknown quantities can be solved directly, to obtain the temperature calibration constant value a and the temperature calibration constant value b , which are then substituted into the temperature calibration formula. In the subsequent temperature calibration process, when the first temperature sensor and the second temperature sensor in the temperature controller respectively detect t₁ and t₂, Δₜ₁ is calculated. Given that the values of the temperature calibration constant value a and the temperature calibration constant value b have been determined, the external ambient temperature t after calibration can be directly obtained. It can be seen that in the process of determining the temperature calibration constant value, the temperature data measured by the external temperature sensor needs to be substituted for the external ambient temperature t after calibration.

Certainly, it should be easily appreciated that, under a condition that the temperature controller includes three or more built-in temperature sensors, a quantity of the temperature calibration constant values may be increased correspondingly, and the temperature calibration constant value is positively correlated with a quantity of temperature sensors included in the temperature controller.

By substituting the temperature data before temperature change and the temperature data after temperature change into the temperature calibration formula, the temperature calibration constant value can be obtained.

Step 4: performing the temperature calibration, by using the temperature calibration formula including the temperature calibration constant value, on the real-time temperature data obtained by the temperature controller.

After determining the temperature calibration constant value in the temperature calibration formula through the step, temperature calibration can be performed on the real-time temperature obtained by the temperature controller. In this step, the real-time temperature may include temperature data measured by each built-in temperature sensor in the temperature controller, for example, may include a measured temperature t₁ of the first temperature sensor and a measured temperature t₂ of the second temperature sensor.

Finally, the temperature calibration formula can be directly used to perform temperature calibration on the real-time temperature data detected by the temperature controller.

In this case, the temperature calibration process corresponding to this embodiment is in the following.

Step 1: obtaining first temperature data of a temperature sensor and second temperature data of a temperature controller in a preset time period.

Step 2: determining whether the first temperature data and the second temperature data meet a temperature equilibrium condition; if so, entering step 3; or if not, entering step 4.

Step 3: calibrating real-time temperature data of the temperature controller according to the first temperature data.

Step 4: determining whether a temperature control is performed currently; if not, enter step 5.

Step 5: controlling the temperature controller in a preset manner to heat up or cool down, to respectively obtain temperature data before temperature change and temperature data after temperature change.

Step 6: substituting the temperature data before temperature change and the temperature data after temperature change into a temperature calibration formula, to obtain a temperature calibration constant value.

Step 7: performing temperature calibration, by using the temperature calibration formula including the temperature calibration constant value, on the real-time temperature data obtained by the temperature controller.

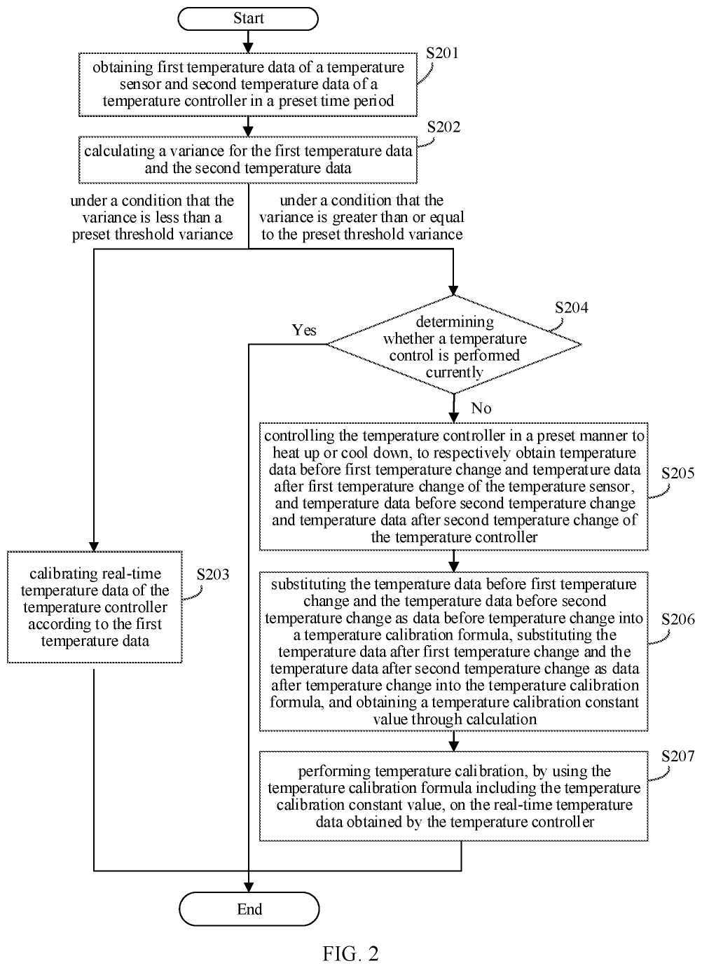

FIG. 2 is a flow diagram of another temperature calibration method according to an embodiment of the application. Under a condition that a variance is used for determining temperature equilibrium, the corresponding temperature calibration process of this embodiment is in the following.

S201: obtaining first temperature data of a temperature sensor and second temperature data of a temperature controller in a preset time period.

S202: calculating a variance for the first temperature data and the second temperature data; under a condition that the variance is less than a preset threshold variance, entering S203; and under a condition that the variance is greater than or equal to the preset threshold variance, entering S204.

S203: calibrating real-time temperature data of the temperature controller according to the first temperature data.

S204: determining whether a temperature control is performed currently; if not, entering S205.

S205: controlling the temperature controller in a preset manner to heat up or cool down, to respectively obtain temperature data before first temperature change and temperature data after first temperature change of the temperature sensor, and temperature data before second temperature change and temperature data after second temperature change of the temperature controller.

S206: substituting the temperature data before first temperature change and the temperature data before second temperature change as data before temperature change into a temperature calibration formula, substituting the temperature data after first temperature change and the temperature data after second temperature change as data after temperature change into the temperature calibration formula, and obtaining a temperature calibration constant value through calculation.

The temperature calibration constant value is positively correlated with a quantity of temperature sensors included in the temperature controller.

S207: performing temperature calibration, by using the temperature calibration formula including the temperature calibration constant value, on the real-time temperature data obtained by the temperature controller.

Based on the embodiment, in an embodiment, under a condition that a wireless connection is used between the temperature controller and the temperature sensor, before obtaining the first temperature data of the temperature sensor and the second temperature data of the temperature controller in the preset time period, an actual distance between the temperature sensor and the temperature controller may be first determined according to a signal strength value, and under a condition that the actual distance is less than a set distance, step S101 in the embodiment is performed.

When the actual distance is relatively great, the temperature controller and the temperature sensor may be at a relatively far distance from each other, or may even be in different spaces, for example, in two rooms. In this case, the temperature of the temperature sensor has no calibration significance for the temperature controller.

How to determine the actual distance between the temperature sensor and the temperature controller according to the signal strength value is not limited herein. Preferably, this embodiment provides a process for calculating the actual distance:

inputting the signal strength value to a preset conversion formula, to obtain the actual distance between the temperature sensor and the temperature controller, where the preset conversion formula is:

d=10^{(abs(RSSI)-A)/(10*n)}

where d is an actual distance between the temperature sensor and the temperature controller, A is an absolute value of power at a unit distance from the temperature sensor, n is free space loss, and the unit of an RSSI is decibels referenced to one milliwatt (dbm). The free space loss refers to energy loss when data returned by the temperature sensor propagates in air in a form of electromagnetic waves. It should be noted that under a condition that the temperature sensor and the temperature controller are in different spaces, for example, are in two relatively closed rooms, the temperature sensor clearly does not have reference value for calibration, and in this case, an RSSI value of the temperature sensor received at the temperature controller is also low due to barriers such as walls.

By substituting the Received Signal Strength Indication (RSSI) value of the temperature sensor received at the temperature controller to the formula, the actual distance d between the temperature sensor and the temperature controller can be directly determined.

In this embodiment, a spatial distance between the temperature controller and the temperature sensor may be determined before performing temperature calibration, to determine whether the temperature sensor can be used for temperature reference, so as to avoid invalid calibration caused by that the temperature sensor and the temperature controller are excessively far away from each other or are not in the same space.

In addition, after obtaining the first temperature data of the temperature sensor and the second temperature data of the temperature controller in the preset time period, a magnitude relationship between a difference between the first temperature data and the second temperature data and a preset threshold may be further determined, so as to determine whether it is necessary to perform the corresponding temperature calibration.

For example, under a condition that the difference between the first temperature data and the second temperature data is not less than a preset threshold, the step of determining whether the first temperature data and the second temperature data meet a temperature equilibrium condition is triggered, to perform temperature calibration.

Under a condition that a difference between the first temperature data and the second temperature data is less than a preset threshold, the temperature calibration is not performed.

Certainly, those skilled in the art may also use other determining processes for determining whether it is necessary to perform temperature calibration on the basis of this embodiment, so as to reduce unnecessary data processing processes and temperature calibration processes, which helps to implement effective temperature control of the temperature controller.

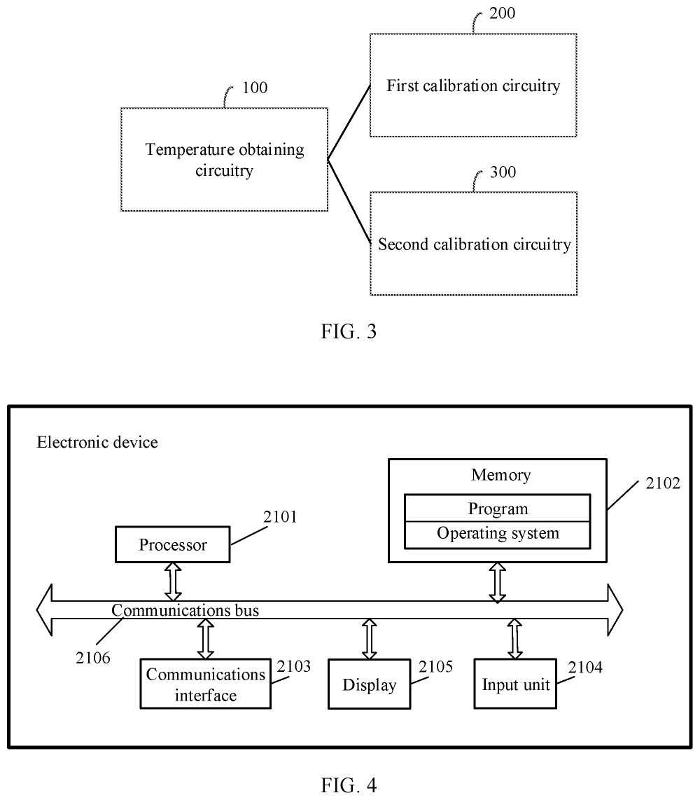

FIG. 3 is a schematic structural diagram of a temperature calibration system according to an embodiment of the application. The application further provides a temperature calibration system, including:

a temperature obtaining circuitry 100, configured to obtain first temperature data of a temperature sensor and second temperature data of a temperature controller in a preset time period;

a first calibration circuitry 200, configured to, based on that the first temperature data and the second temperature data meet a temperature equilibrium condition, calibrate real-time temperature data of the temperature controller according to the first temperature data; and

a second calibration circuitry 300, configured to, based on that the first temperature data and the second temperature data do not meet the temperature equilibrium condition, determine a temperature calibration constant value according to third temperature data of the temperature sensor and fourth temperature data of the temperature controller when temperature control is not performed and perform temperature calibration, by using a temperature calibration formula including the temperature calibration constant value, on the real-time temperature data obtained by the temperature controller.

Based on the embodiments, an embodiment further includes:

a temperature equilibrium determining module, configured to calculate a first variance corresponding to the first temperature data and a second variance corresponding to the second temperature data; under a condition that the first variance and the second variance are both less than a preset threshold variance, enter the first calibration circuitry 200; and

under a condition that at least one of the first variance and the second variance is not less than the preset threshold variance, determine that the first temperature data and the second temperature data do not meet the temperature equilibrium condition.

Based on the embodiment, in an embodiment, the second calibration circuitry 300 includes:

a data obtaining unit, configured to, when the temperature control is not performed, control the temperature controller in a preset manner to heat up or cool down, to respectively obtain temperature data before first temperature change and temperature data after first temperature change of the temperature sensor, and temperature data before second temperature change and temperature data after second temperature change of the temperature controller, where the third temperature data includes the temperature data before first temperature change and the temperature data after first temperature change and the fourth temperature data includes the temperature data before second temperature change and the temperature data after second temperature change;

a constant calculating unit, configured to substitute the temperature data before first temperature change and the temperature data before second temperature change as data before temperature change into the temperature calibration formula, substitute the temperature data after first temperature change and the temperature data after second temperature change as data after temperature change into the temperature calibration formula, and obtain the temperature calibration constant value through calculation, where the temperature calibration constant value is positively correlated with a quantity of temperature sensors included in the temperature controller; and

a temperature calibration unit, configured to perform temperature calibration, by using the temperature calibration formula including the temperature calibration constant value, on the real-time temperature data obtained by the temperature controller.

Based on the embodiments, an embodiment further includes:

a distance detection module, configured to determine an actual distance between the temperature sensor and the temperature controller according to a signal strength value; and under a condition that the actual distance is less than a set distance, enter the temperature obtaining circuitry 100.

Based on the embodiments, in an embodiment, the distance detection module further includes:

a distance calculating unit, configured to input the signal strength value to a preset conversion formula, to obtain the actual distance between the temperature sensor and the temperature controller, where

the preset conversion formula is:

d=10^{(abs(RSSI)-A)/(10*n)}

where d is a distance between the temperature sensor and the temperature controller, A is an absolute value of power at a unit distance from the temperature sensor, n is free space loss, and the unit of an RS SI is decibels referenced to one milliwatt (dbm).

The application further provides a computer-readable storage medium, storing a computer program, where the computer program, when executed, implements the operations of the temperature calibration method according to the embodiments. The storage medium may include: any medium that can store program code, such as a USB flash drive, a removable hard disk, a Read-Only Memory (ROM), a Random Access Memory (RAM), a magnetic disk, or an optical disc.

The application further provides an electronic device, which may include a memory and a processor, where the memory stores a computer program, and the processor, when invoking the computer program stored in the memory, implements the operations of the temperature calibration method according to the embodiments. Certainly, the electronic device may also include various components such as network interfaces and power supplies. FIG. 4 is a schematic structural diagram of an electronic device according to an embodiment of the application. The electronic device of this embodiment may include: a processor 2101, a memory 2102, and at least one built-in temperature sensor.

Optionally, the electronic device may further include a communications interface 2103, an input unit 2104, a display 2105, and a communications bus 2106.

The processor 2101, the memory 2102, the communications interface 2103, the input unit 2104, and the display 2105 all communicate with each other through the communications bus 2106.

In the embodiments of the application, the processor 2101 may be a central processing unit (CPU), a specific application integrated circuit, a digital signal processor, a field programmable gate array, or other programmable logic devices.

The processor may invoke the program stored in the memory 2102 and process the temperature data detected by the built-in temperature sensor and the temperature data sent by an outside temperature sensor. Specifically, the processor may perform the temperature calibration operation performed in the embodiments.

The memory 2102 is configured to store one or more programs, the program may include program code, the program code includes computer operating instructions, and in the embodiments of the application, the memory stores at least a program for the following functions:

obtaining first temperature data of a temperature sensor and second temperature data of a temperature controller in a preset time period;

calculating a variance for the first temperature data and the second temperature data;

under a condition that the variance is less than a preset threshold variance, calibrating real-time temperature data of the temperature controller according to the first temperature data; and

under a condition that the variance is greater than the preset threshold variance, determining a temperature calibration constant value when temperature control is not performed and performing temperature calibration, by using a temperature calibration formula including the temperature calibration constant value, on the real-time temperature data obtained by the temperature controller.

In a possible implementation, the memory 2102 may include a storage program area and a storage data area. The storage program area may store an operating system, and an application program required for at least one function (for example, a topic detection function, or the like), and the storage data area may store data created during the use of the computer.

In addition, the memory 2102 may include a high-speed random access memory, and may also include a non-volatile memory, such as at least one magnetic disk memory device or other volatile solid-state memory device, which may be used to store at least one of temperature data of a built-in temperature sensor, temperature data of an external temperature sensor, and a temperature control instruction sent by an electronic device.

The communications interface 2103 may be an interface of the communications module, such as an interface of the GSM module.

The application may also include a display 2105, an input unit 2104, and the like.

The structure of the electronic device shown in FIG. 4 does not constitute a limitation to the electronic device in the embodiment of the application, and the electronic device may include more or less components than those shown in FIG. 4.

Each embodiment in the specification is described in a progressive manner, each embodiment focuses on the difference from other embodiments, and the same or similar parts between the embodiments can be referred to each other. For the system provided by the embodiment, since it corresponds to the method provided in the embodiment, the description is relatively simple, and reference can be made to the description in the method section for relevant matters.

The principles and implementation of the application are described herein, and the description of the embodiments is only used to help understand the method of the application and core ideas of the application. It should be noted that, those of ordinary skill in the art may also make several improvements and modifications to the application without departing from the principles of the application, and these improvements and modifications also fall in the scope of protection of the claims of the application.

It should also be noted that in this specification, relational terms such as first and second are only used to distinguish one entity or operation from another entity or operation, and do not necessarily require or imply any such actual relationship or numerical sequence between these entities or operations. Moreover, the terms “comprise”, “include”, or any other variant thereof are intended to encompass non-exclusive inclusions such that a process, method, object, or device including a series of elements includes not only those elements, but also other elements not explicitly listed, or also includes elements inherent to such process, method, article or device. Without further limitation, the elements defined by the sentence “including a . . . ” do not preclude the existence of other identical elements in the process, method, object, or device including the elements.

What is claimed is:

1. A temperature calibration method, comprising:
obtaining first temperature data of a temperature sensor and second temperature data of a temperature controller in a preset time period;
under a condition that said first temperature data and said second temperature data meet a temperature equilibrium condition, calibrating real-time temperature data of said temperature controller according to said first temperature data; and
under a condition that said first temperature data and said second temperature data do not meet said temperature equilibrium condition, determining a temperature calibration constant value according to third temperature data of said temperature sensor and fourth temperature data of said temperature controller when temperature control is not performed and performing temperature calibration, by using a temperature calibration formula comprising said temperature calibration constant value, on said real-time temperature data obtained by said temperature controller.

2. The temperature calibration method, as recited in claim 1, further comprising:
calculating a first variance corresponding to said first temperature data and a second variance corresponding to said second temperature data;
under a condition that said first variance and said second variance are both less than a preset threshold variance, determining that said first temperature data and said second temperature data meet said temperature equilibrium condition; and
under a condition that at least one of said first variance and said second variance is not less than said preset threshold variance, determining that said first temperature data and said second temperature data do not meet said temperature equilibrium condition.

3. The temperature calibration method, as recited in claim 1, wherein said determining said temperature calibration constant value according to said third temperature data of said temperature sensor and said fourth temperature data of said temperature controller when said temperature control is not performed and performing temperature calibration, by using said temperature calibration formula comprising said temperature calibration constant value, on said real-time temperature data obtained by said temperature controller comprises:
when said temperature control is not performed, controlling said temperature controller in a preset manner to heat up or cool down, to respectively obtain temperature data before first temperature change and temperature data after first temperature change of said temperature sensor, and temperature data before second temperature change and temperature data after second temperature change of said temperature controller, wherein said third temperature data comprises said temperature data before first temperature change and said temperature data after first temperature change and said fourth temperature data comprises said temperature data before second temperature change and said temperature data after second temperature change;
substituting said temperature data before first temperature change and said temperature data before second temperature change as data before temperature change into said temperature calibration formula, substituting said temperature data after first temperature change and said temperature data after second temperature change as data after temperature change into said temperature calibration formula, and obtaining said temperature calibration constant value through calculation, wherein said temperature calibration constant value is positively correlated with a quantity of temperature sensors comprised in said temperature controller; and
performing said temperature calibration, by using said temperature calibration formula comprising said temperature calibration constant value, on said real-time temperature data obtained by said temperature controller.

4. The temperature calibration method, as recited in claim 3, wherein under a condition that said temperature controller comprises a first temperature sensor and a second temperature sensor, said temperature calibration formula is:
t=t₁−(a+Δₜ₁*b)*(t₂−t₁)
wherein t is an external ambient temperature after calibration, t₁ is a measured temperature of said first temperature sensor, t₂ is a measured temperature of said second temperature sensor, Δ₁ is a temperature change rate of said first temperature sensor, and a and b are said temperature calibration constant values.

5. The temperature calibration method, as recited in claim 3, further comprising:
under a condition that a latest control instruction of said temperature controller in said preset time period is to terminate a temperature control operation, determining that said temperature control is not performed currently.

6. The temperature calibration method, as recited in claim 1, wherein before said obtaining first temperature data of said temperature sensor and second temperature data of said temperature controller in said preset time period, said method further comprises:
determining an actual distance between said temperature sensor and said temperature controller according to a signal strength value; and
under a condition that said actual distance is less than a set distance, performing operation of said obtaining first temperature data of said temperature sensor and second temperature data of said temperature controller in a preset time period.

7. The temperature calibration method, as recited in claim 1, wherein after said obtaining said first temperature data of said temperature sensor and said second temperature data of said temperature controller in said preset time period, said method further comprises:
under a condition that a difference between said first temperature data and said second temperature data is not less than a preset threshold, triggering operation of determining whether said first temperature data and said second temperature data meet said temperature equilibrium condition, and performing said temperature calibration; and
under a condition that said difference between said first temperature data and said second temperature data is less than said preset threshold, skipping said temperature calibration.

8. A temperature calibration system, comprising:
a temperature obtaining circuitry, configured to obtain first temperature data of a temperature sensor and second temperature data of a temperature controller in a preset time period;
a first calibration circuitry, configured to, based on that said first temperature data and said second temperature data meet a temperature equilibrium condition, calibrate real-time temperature data of said temperature controller according to said first temperature data; and
a second calibration circuitry, configured to, based on that said first temperature data and said second temperature data do not meet said temperature equilibrium condition, determine a temperature calibration constant value according to third temperature data of said temperature sensor and fourth temperature data of said temperature controller when temperature control is not performed and perform temperature calibration, by using a temperature calibration formula comprising said temperature calibration constant value, on said real-time temperature data obtained by said temperature controller.

9. An electronic device, comprising a processor and a memory, wherein program instructions are stored in the memory, and when said program instructions are executed by the processor, the processor is enabled to perform:
obtaining first temperature data of a temperature sensor and second temperature data of a temperature controller in a preset time period;
under a condition that said first temperature data and said second temperature data meet a temperature equilibrium condition, calibrating real-time temperature data of said temperature controller according to said first temperature data; and
under a condition that said first temperature data and said second temperature data do not meet said temperature equilibrium condition, determining a temperature calibration constant value according to third temperature data of said temperature sensor and fourth temperature data of said temperature controller when temperature control is not performed and performing temperature calibration, by using a temperature calibration formula comprising said temperature calibration constant value, on said real-time temperature data obtained by said temperature controller.

10. The electronic device, as recited in claim 9, further comprising:
calculating a first variance corresponding to said first temperature data and a second variance corresponding to said second temperature data;
under a condition that said first variance and said second variance are both less than a preset threshold variance, determining that said first temperature data and said second temperature data meet said temperature equilibrium condition; and
under a condition that at least one of said first variance and said second variance is not less than said preset threshold variance, determining that said first temperature data and said second temperature data do not meet said temperature equilibrium condition.

11. The electronic device, as recited in claim 9, wherein said determining said temperature calibration constant value according to said third temperature data of said temperature sensor and said fourth temperature data of said temperature controller when said temperature control is not performed and performing temperature calibration, by using said temperature calibration formula comprising said temperature calibration constant value, on said real-time temperature data obtained by said temperature controller comprises:
when said temperature control is not performed, controlling said temperature controller in a preset manner to heat up or cool down, to respectively obtain temperature data before first temperature change and temperature data after first temperature change of said temperature sensor, and temperature data before second temperature change and temperature data after second temperature change of said temperature controller, wherein said third temperature data comprises said temperature data before first temperature change and said temperature data after first temperature change and said fourth temperature data comprises said temperature data before second temperature change and said temperature data after second temperature change;
substituting said temperature data before first temperature change and said temperature data before second temperature change as data before temperature change into said temperature calibration formula, substituting said temperature data after first temperature change and said temperature data after second temperature change as data after temperature change into said temperature calibration formula, and obtaining said temperature calibration constant value through calculation, wherein said temperature calibration constant value is positively correlated with a quantity of temperature sensors comprised in said temperature controller; and
performing said temperature calibration, by using said temperature calibration formula comprising said temperature calibration constant value, on said real-time temperature data obtained by said temperature controller.

12. The electronic device, as recited in claim 11, wherein under a condition that said temperature controller comprises a first temperature sensor and a second temperature sensor, said temperature calibration formula is:
t=t₁−(a+Δₜ₁*b)*(t₂−t₁)
wherein t is an external ambient temperature after calibration, t₁ is a measured temperature of said first temperature sensor, t₂ is a measured temperature of said second temperature sensor, Δ₁ is a temperature change rate of said first temperature sensor, and a and b are said temperature calibration constant values.

13. The electronic device, as recited in claim 11, further comprising:
under a condition that a latest control instruction of said temperature controller in said preset time period is to terminate a temperature control operation, determining that said temperature control is not performed currently.

14. The electronic device, as recited in claim 9, wherein before said obtaining first temperature data of said temperature sensor and second temperature data of said temperature controller in said preset time period, said electronic device further comprises:
determining an actual distance between said temperature sensor and said temperature controller according to a signal strength value; and
under a condition that said actual distance is less than a set distance, performing operation of said obtaining first temperature data of said temperature sensor and second temperature data of said temperature controller in a preset time period.

15. The electronic device, as recited in claim 9, wherein after said obtaining said first temperature data of said temperature sensor and said second temperature data of said temperature controller in said preset time period, said electronic device further comprises:
under a condition that a difference between said first temperature data and said second temperature data is not less than a preset threshold, triggering operation of determining whether said first temperature data and said second temperature data meet said temperature equilibrium condition, and performing said temperature calibration; and
under a condition that said difference between said first temperature data and said second temperature data is less than said preset threshold, skipping said temperature calibration.
